(19) United States
(12) Patent Application Publication
(10) Pub. No.: US 2026/0299176 A1
(43) Pub. Date: Oct. 1, 2026

(54) DISPLAY DEVICE AND LIGHT DIFFUSION OPTICAL FILM THEREOF

(71) Applicant: Twin Beam Co., Ltd., Taoyuan City (TW)

(72) Inventor: Huan-Hui LU, Taoyuan City (TW)

(21) Appl. No.: 19/565,151

(22) Filed: Mar. 12, 2026

(30) Foreign Application Priority Data
Mar. 27, 2025 (TW) 114111844

(51) Int. Cl. G02B 5/02; G02F 1/1335

(52) U.S. Cl. CPC G02B 5/0231; G02B 5/0221; G02F 1/133607

(57) ABSTRACT

A light diffusion optical film includes a first substrate, a core layer and a light diffusion structure. The core layer is formed on the first substrate and has a mounting surface. A first direction and a second direction orthogonal to each other are defined on the setting surface. The light diffusion structure is formed on the mounting surface of the core layer. The light diffusion structure is a union of a plurality of micro-structural bodies extending along a first direction and a second direction. Each micro-structural body includes a first surface and a second surface arranged opposite to each other. The first surface intersects with the mounting surface at a first boundary, the second surface intersects with the mounting surface at a second boundary, and the first surface and the second surface intersect at a ridge. The first boundary is a straight line or a first curve, the second boundary is a straight line or a second curve, and the ridge is a straight line or a third curve.

### BACKGROUND OF THE INVENTION

### Field of the Invention

The invention relates to a technical field of optical film, and more particularly to an optical film for light diffusion and a display device having the same.

### Description of the Related Art

The conventional liquid crystal display device includes a backlight module, a liquid crystal display panel and a light polarizing sheet. The backlight module generates an illuminating light beam. The illuminating light beam penetrates the liquid crystal display panel to form an image. When a non-polarized light beam enters the light polarizing sheet, the light polarized in a direction parallel with the light polarizing sheet is allowed to pass through the light polarizing sheet and therefore becomes a polarized light. The light polarized in a direction perpendicular to the light polarizing sheet is blocked thereby. When the polarized light beam passes through the liquid crystal display panel, molecules of the liquid crystal spin in each pixel to serve as a light gate allowing the polarized light passing therethrough or not.

However, as the light beam from the backlight module is randomly polarized, the amount of light available for illuminating the liquid crystal display panel is inherently less than the total light emitted from the backlight module, leading to a reduction in light intensity on the display panel. Therefore, a technology has been developed to maximize the light amount entering the liquid crystal display panel and minimize the light blocked by the light polarizing sheet. This involves disposing a reflective polarizing sheet between the backlight module and an LC panel to re-utilize at least a portion of the blocked light.

The conventional reflective polarizing sheet includes a substrate made of polyester, a core layer disposed on the substrate and micro structures formed on the core layer. The micro structures are formed by roughening a surface of the core layer. For example, particles of different coarse diameters are attached on the surface of the core layer, or an embossing mold presses the surface of the core layer, thereby forming the roughened structure on the surface.

As the particles attached to the surface of the core layer have different coarse diameters, and the particles having semi-spherical or irregular structures are randomly accumulated on the surface of the core layer, the light beams may be scattered by the irregularly roughened structure to travel at different angles and therefore reduce transmittance of the light, thereby reducing light intensity of the display device.

### BRIEF SUMMARY OF THE INVENTION

The invention provides an optical film for light diffusion and a display device having the same. The optical film in accordance with an exemplary embodiment of the invention includes a first substrate, a core layer formed on the first substrate and configured to optically affect a light beam incident into the optical film, and a light diffusion structure formed on the mounting surface and configured to diffuse the light beam. The core layer includes a mounting surface adjacent to the substrate, and a first direction and a second direction mutually intersecting are defined on the mounting surface. The light diffusion structure includes a micro-structured layer being a union of a plurality micro-structural bodies extending along the first direction and the second direction, each of the micro-structural bodies includes a first surface and a second surface opposite to the first surface, the first surface intersects the mounting surface at a first boundary, the second surface intersects the mounting surface at a second boundary, the first surface intersects the second surface at a connection, the first boundary is a line or a first curve, the second boundary a line or a second curve, the connection is a ridge or a rounded surface, and the ridge is a line or a third curve.

In some embodiments, the first curve is a first wavy curve having a plurality of wave crests and a plurality of wave troughs alternately disposed along the first direction and the second direction.

In yet some embodiments, the second curve is a second wavy curve having a plurality of wave crests and a plurality of wave troughs alternately disposed along the first direction and the second direction.

In some embodiments, the third curve is a third wavy curve having a plurality of wave crests and a plurality of wave troughs alternately disposed along the first direction and the second direction.

In some embodiments, the first boundary is the first wavy curve, the second boundary is the second wavy curve, the wave crests of the first wavy curve correspond to the wave crests of the second wavy curve, and the wave troughs of the first wavy curve correspond to the wave troughs of the second wavy curve.

In some embodiments, the first boundary is the first wavy curve, the second boundary is the second wavy curve, the wave crests of the first wavy curve of one of the micro-structural bodies corresponds to the wave crests of the first wavy curve of adjacent another one of the micro-structural bodies, and the wave troughs of the first wavy curve of one of the micro-structural bodies corresponds to the wave troughs of the first wavy curve of adjacent another one of the micro-structural bodies.

In some embodiments, the first boundary is the first wavy curve, the second boundary is the second wavy curve, the wave crests of the first wavy curve of one of the micro-structural bodies corresponds to the wave troughs of the first wavy curve of adjacent another one of the micro-structural bodies, and the wave troughs of the first wavy curve of one of the micro-structural bodies corresponds to the wave crests of the first wavy curve of adjacent another one of the micro-structural bodies.

In some embodiments, the ridge is the third wavy curve, the wave crests of the third wavy curve correspond to the wave crests of the first wavy curve, and the wave troughs of the third wavy curve correspond to the wave troughs of the first wavy curve.

In some embodiments, the first boundary is the line, the second boundary is the line, the ridge is a third wavy curve having a plurality of wave crests and a plurality of wave troughs alternately disposed along a third direction perpendicular to the first direction and the second direction.

In some embodiments, the micro-structured layer includes a plurality of first ridges extending along the first direction and a plurality of second ridges extending along the second direction, at least one of the first ridges is continuous, and at least one of the second ridges is non-continuous.

In some embodiments, the micro-structured layer includes a plurality of depressed portions, each of the depressed portions is disposed between two adjacent first ridges and two adjacent second ridges.

In some embodiments, each of the depressed portions has a bottom shaped as at least one or any combination of a group of geometrical structure composed of a point, a line, a curve, a plane or a conical surface.

In some embodiments, the first direction and the second direction intersect at an angle ranging from 45° to 135°.

In some embodiments, the light diffusion structure further includes a second substrate formed on the core layer, and the micro-structured layer is formed on the second substrate.

In some embodiments, the rounded surface has a radius of curvature ranging from 0.2 μm to 30 μm in the first direction or the second direction.

The display device in accordance with an exemplary embodiment of the invention includes a backlight module emitting a non-polarized light beam, the aforementioned optical film, and a liquid crystal display panel. The non-polarized light beam passes through the core layer of the optical film to form a polarized light beam, and the light diffusion structure diffuse the polarized light beam to form a two-dimensional light beam. The two-dimensional light beam passes through the liquid crystal display panel to form an image light beam.

The light diffusion structure of the optical film for light diffusion is formed by a union of a plurality of micro-structural bodies extending along the first direction and the second direction. The first boundary, the second boundary and the ridge of each micro-structural body are formed by a line or a curve, and the curve is periodical or non-periodical. When multiple micro-structural bodies of different shapes or arrangements are combined, a structure composed of ridges and depressed portions alternately arranged is formed. When illuminating light beams pass through the micro-structural bodies, the light beams are scattered by the micro-structural bodies to travel at substantially the same angle for a uniform light diffusion effect.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an optical film for light diffusion of the present invention;

FIG. 2 is a perspective view of an embodiment of a light diffusion structure of an optical film for light diffusion of the present invention;

FIG. 3 is a top view of FIG. 2;

FIG. 4 is a cross section of an embodiment of an optical film for light diffusion of the present invention;

FIG. 5 is a cross section of another embodiment of an optical film for light diffusion of the present invention;

FIG. 6 is a cross section of yet another embodiment of an optical film for light diffusion of the present invention;

FIG. 7 is a perspective view of an arrangement of a plurality of micro-structural bodies extending along a first direction and a second direction;

FIG. 8 is a top view of FIG. 7;

FIG. 9 is a top view of a first embodiment of a micro-structural body of the invention;

FIG. 10 is a top view of a second embodiment of a micro-structural body of the invention;

FIG. 11 a top view of a third embodiment of a micro-structural body of the invention; and

FIG. 12 a top view of a fourth embodiment of a micro-structural body of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

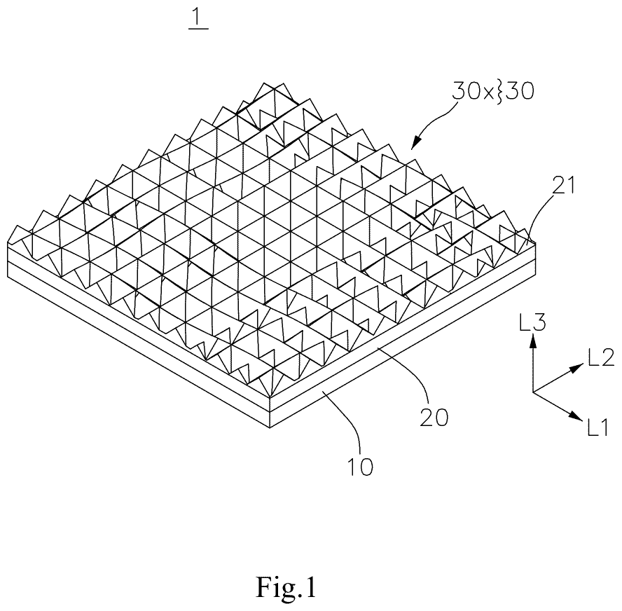

Referring to FIG. 1, an embodiment of a light diffusion structure of an optical film for light diffusion of the present invention is disclosed. The optical film 1 for light diffusion of the present embodiment includes a first substrate 10, a core layer 20 and a light diffusion structure 30. The first substrate 10 is a polymer substrate. The core layer 20 is formed on the first substrate 10 and configured to provide an optical effect for incident light beams. The optical effect is exemplarily polarization of a non-polarized light passing through the core layer 20.

The core layer 20 has two opposite surfaces. One of the surfaces is adjacent to the substrate 10, and the other one is defined as a mounting surface 21. A first direction L1 and a second direction L2 are defined on the mounting surface 21. The first direction L1 and the second direction L2 are orthogonal, but the invention is not limited thereto. In other embodiments, the first direction L1 and the second direction L2 intersect at an angle ranging from 45° to 135°. The light diffusion structure 30 is formed on the mounting surface 21 of the core layer 20. The light diffusion structure 30 is configured to diffuse the light beams. The light diffusion structure 30 has a refraction index ranging from 1.45 to 1.90, and preferably 1.55.

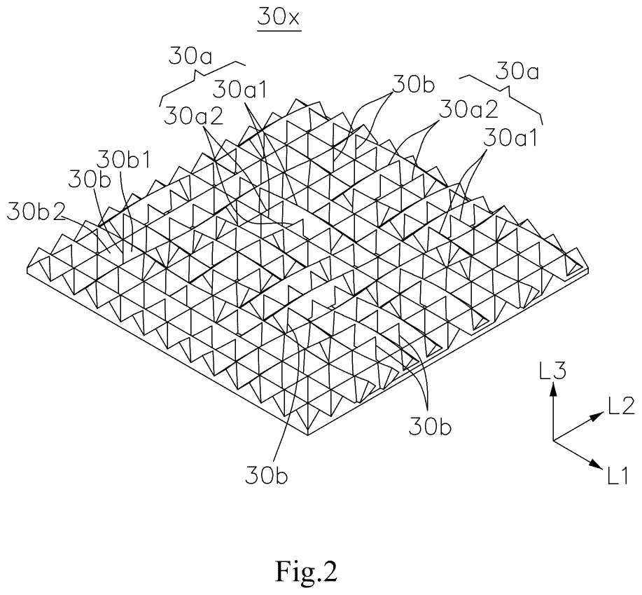

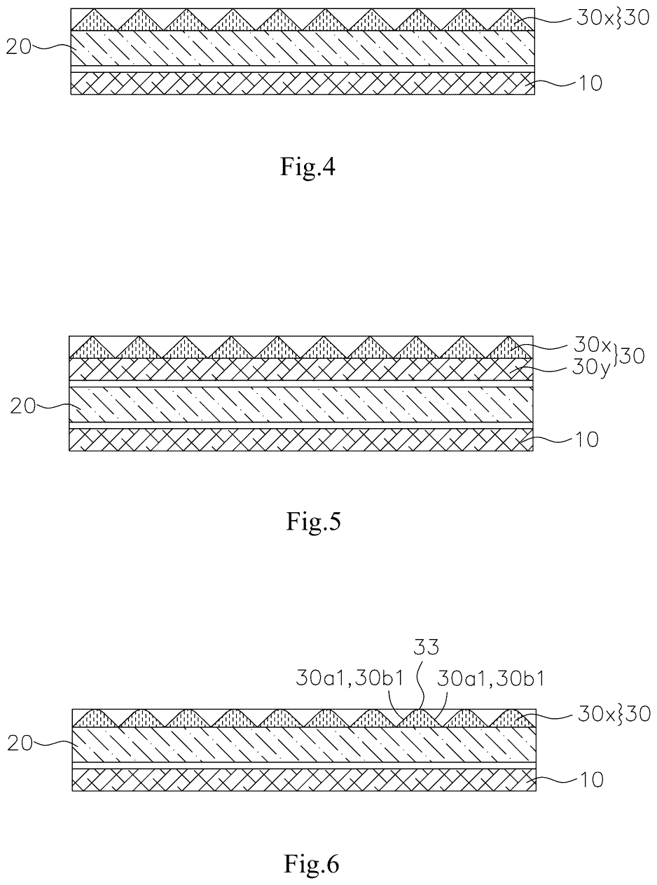

Referring to FIGS. 2, 3 and 4, an embodiment of a light diffusion structure of the optical film for light diffusion of the present invention is disclosed. The light diffusion structure 30 includes a micro-structured layer 30x. The micro-structured layer 30x includes a plurality of ridges 30a and a plurality of depressed portion 30b. The ridges 30a substantially extends along the first direction L1 and the second direction L2. Two first ridges 30a1 extending along the first direction L1 intersect two second ridges 30a2 extending along the second direction L2, and a depressed portion 30b is formed between the first ridges 30a1 and the second ridges 30a2. The depressed portion 30b includes two inclined surfaces 30b1 slantly extending from the two adjacent first ridges 30a1 respectively and two inclined surface 30b2 slantly extending from the two adjacent second ridges 30a2 respectively. The inclined surfaces 30b1 and the inclined surfaces 30b2 are inclined with respect to the mounting surface 21. The inclined surfaces 30b1 and the inclined surfaces 30b2 are exemplarily planes or curved surfaces.

The inclined surfaces 30b1 and inclined surfaces 30b2 are connected to a bottom of the depressed portion 30b due to the shapes, the heights or the extending status of two adjacent first ridges 30a1 and two adjacent second ridges 30a2. When the inclined surfaces 30b1 and the inclined surfaces 30b2 are planes, the bottom of the depressed portion 30b becomes a point, a line or a plane. When the inclined surfaces 30b1 and the inclined surfaces 30b2 are curved surfaces, the bottom of the depressed portion 30b becomes a curve or a conical surface.

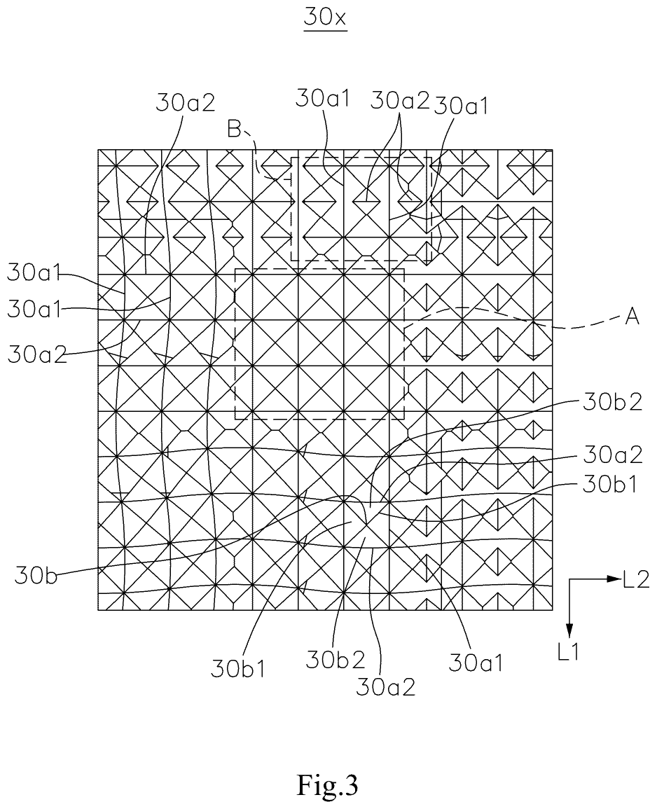

Moreover, as shown in FIG. 3, as the first ridge 30a1 and the second ridge 30a2 have the same height in a region A, the first ridge 30a1 and the second ridge 30a2 are continuous lines or continuous curves. As the first ridge 30a1 and the second ridge 30a2 have different heights in a region B, and the second ridge 30a2 has a height smaller than that of the first ridge 30a1, the first ridge 30a1 is a continuous line or a continuous curve, and however the second ridge 30a2 is a non-continuous line or a non-continuous curve.

Referring to FIG. 5, another embodiment of the optical film for light diffusion of the present invention is disclosed. As the present embodiment has a structure partially identical to that of the previous embodiment, the same component is given to an identical numerical, and the description thereof is thus omitted. In the present embodiment, the light diffusion structure 30 further includes a second substrate 30y. The micro-structured layer 30x is formed on the second substrate 30y, and the second substrate 30y is formed on the core layer 20. The second substrate 30y is made of a material the same as or different from the first substrate 10.

Referring to FIG. 6, yet another embodiment of the optical film for light diffusion of the present invention is disclosed. As the present embodiment has a structure partially identical to that of the previous embodiment, the same component is given to an identical numerical, and the description thereof is thus omitted. In the present embodiment, the adjacent two inclined surfaces 30b1 are connected to a rounded surface 33, or the adjacent two inclined surfaces 30b2 are connected to the rounded surface 33. The rounded surface 33 extends along the first direction L1 or the second direction L2. The rounded surface 33 has a cross section having a curve provided with a radius of curvature ranging from 0.2 μm to 30 μm.

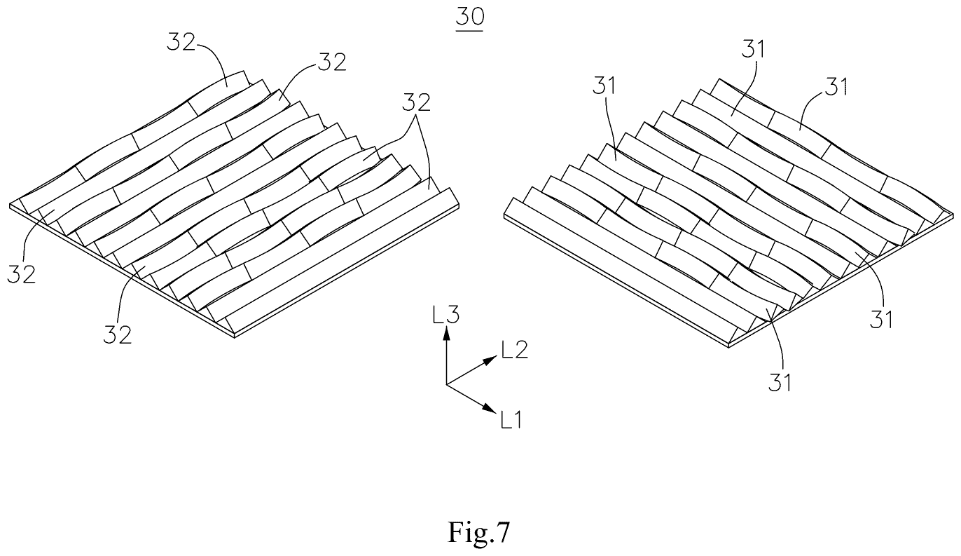

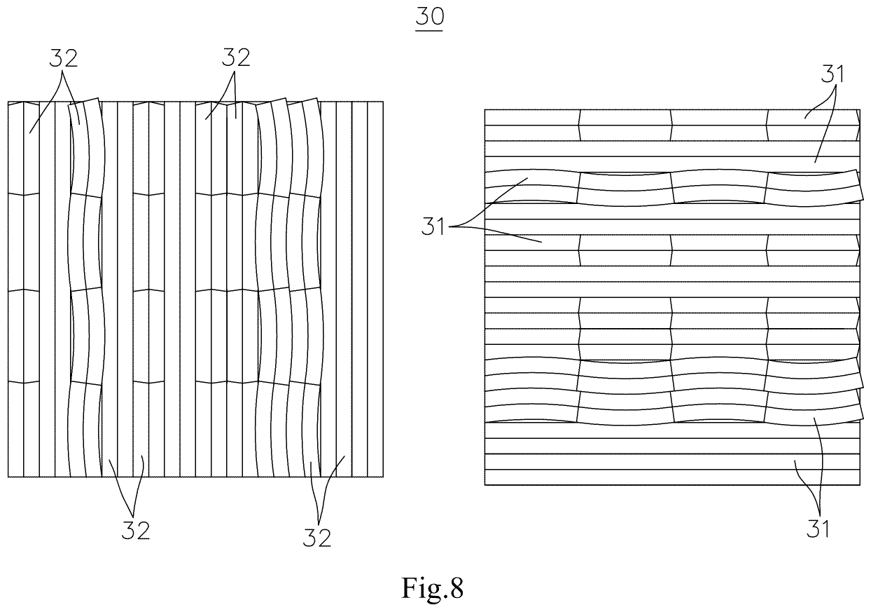

Referring to FIGS. 7 and 8, the light diffusion structure 30 includes a plurality of micro-structural bodies arranged along the first direction L1 and the second direction L2. The light diffusion structure 30 is a union of a plurality of micro-structural bodies 31 extending along the first direction L1 and a plurality of micro-structural bodies 32 extending along the second direction L2. The plurality of micro-structural bodies 31 extending along the first direction L1 are connected to each other, and the plurality of micro-structural bodies 32 extending along the second direction L2 are also connected to each other.

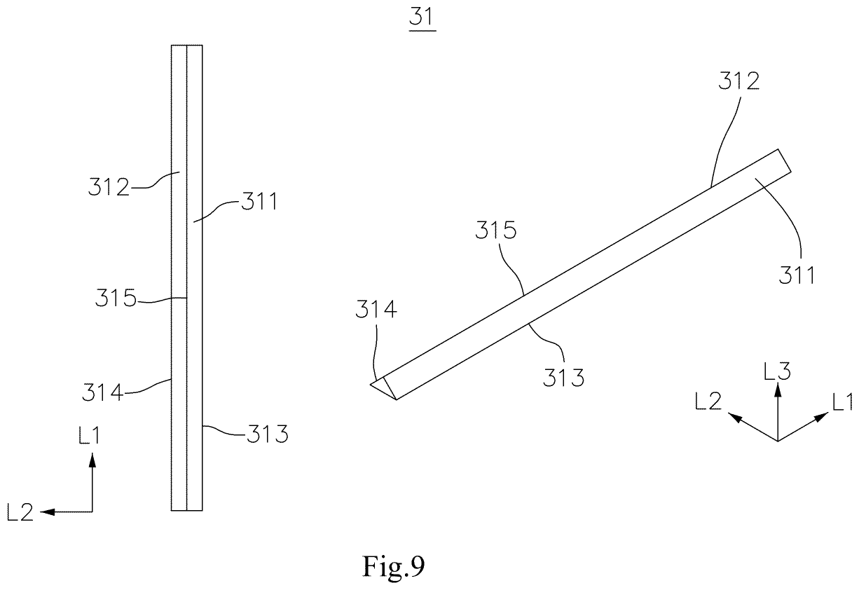

Referring to FIGS. 9, 10, 11 and 12, a first embodiment, a second embodiment, a third embodiment and a fourth embodiment of the micro-structural body are disclosed. The micro-structural bodies 31 have the same structure and shape as the micro-structural bodies 32, but the micro-structural bodies 31 differ from the micro-structural bodies 32 in the extending direction, the first direction L1 and the second direction L2. Therefore, the structure of the micro-structural body 31 is described as an example, and it is also applied to the structure of the micro-structural body 32.

As shown in FIG. 9, the micro-structural body 31 includes a first surface 311 and a second surface 312. The first surface 311 intersects the mounting surface 21 at a first boundary 313, the second surface 312 intersects the mounting surface 21 at a second boundary 314, and the first surface 311 and the second surface 312 intersects at a ridge 315 (or form a rounded surface). As the first surface 311 and the second surface 312 of the present embodiment are planes, the first boundary 313, the second boundary 314 and the ridge 315 are lines.

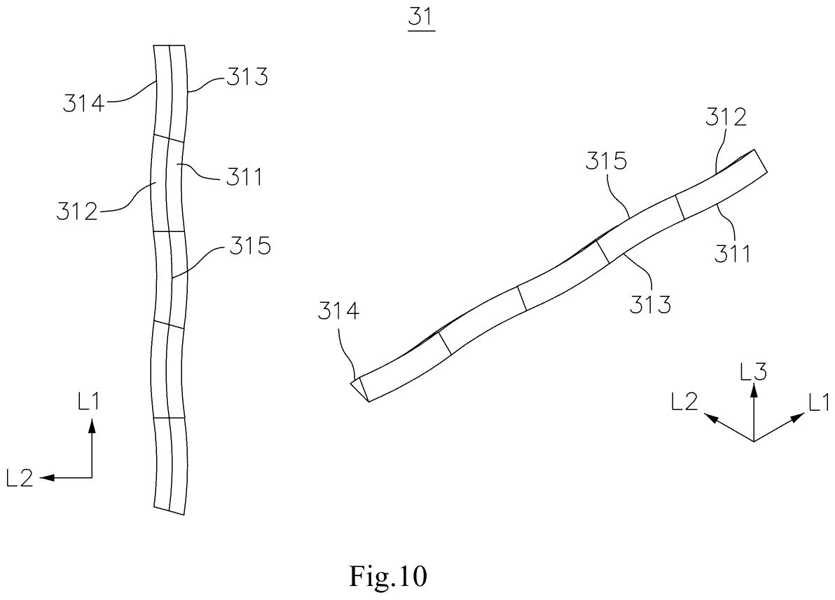

As shown in FIG. 10, the first surface 311 and the second surface 312 of the micro-structural body 31 are curved surfaces, whereby the first boundary 313 is a first curve and the second boundary 314 is a second curve. The first curve is a first wavy curve provided with a plurality of wave crests and a plurality of wave troughs alternately arranged. The second curve is a second wavy curve provided with a plurality of wave crests and a plurality of wave troughs alternately arranged. The plurality of wave crests of the first wavy curve corresponds to the plurality of wave crests of the second wavy curve, and the plurality of wave troughs of the first wavy curve corresponds to the plurality of wave troughs of the second wavy curve. The ridge 315 is a third curve, a third wavy curve provided with a plurality of wave crests and a plurality of wave troughs alternately arranged. The plurality of wave crests of the third wavy curve corresponds to the plurality of wave crests of the first wavy curve, and the plurality of wave troughs of the third wavy curve corresponds to the plurality of wave troughs of the first wavy curve. The wave crests and the wave troughs of the first wavy curve, the second wavy curve and the third wavy curve are formed by variation of their amplitudes along the second direction L2.

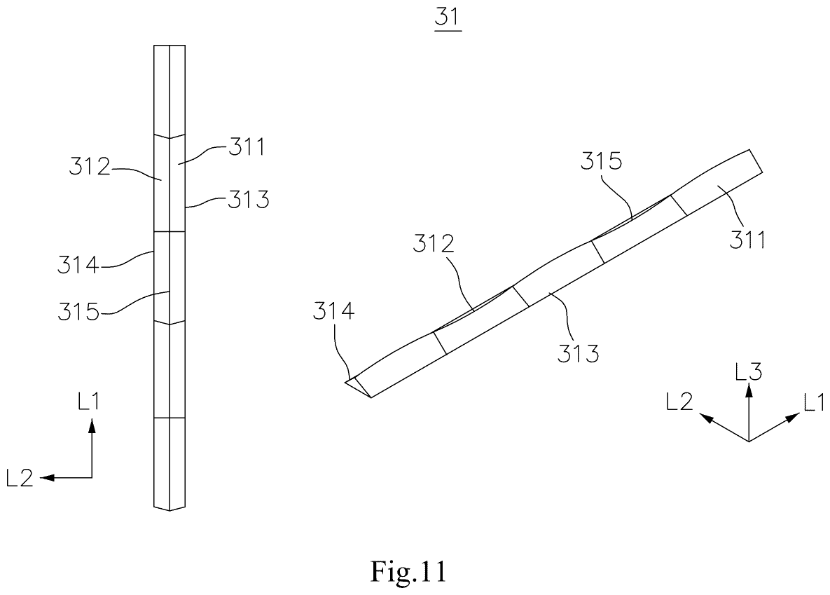

As shown in FIG. 11, the first surface 311 and the second surface 312 of the micro-structural body 31 are curved surfaces, whereby the first boundary 313 is a first curve, the second boundary 314 is a second curve, and the ridge 315 is a third curve. The first curve is a first wavy curve, the second curve is a second wavy curve, and the third curve is a third wavy curve. The wave crests of the first wavy curve, the second wavy curve and the third wavy curve correspond to one another, and the wave troughs of the first wavy curve, the second wavy curve and the third wavy curve correspond to one another. The wave crests and the wave troughs of the first wavy curve, the second wavy curve and the third wavy curve are formed by variation of their amplitudes along the second direction L2. The wave crests of the first wavy curve, the second wavy curve and the third wavy curve of the micro-structural body 31 shown in FIG. 11 corresponds to wave troughs of the first wavy curve, the second wavy curve and the third wavy curve of the micro-structural body 31 shown in FIG. 10. The wave troughs of the first wavy curve, the second wavy curve and the third wavy curve of the micro-structural body 31 shown in FIG. 11 corresponds to wave crests of the first wavy curve, the second wavy curve and the third wavy curve of the micro-structural body 31 shown in FIG. 10.

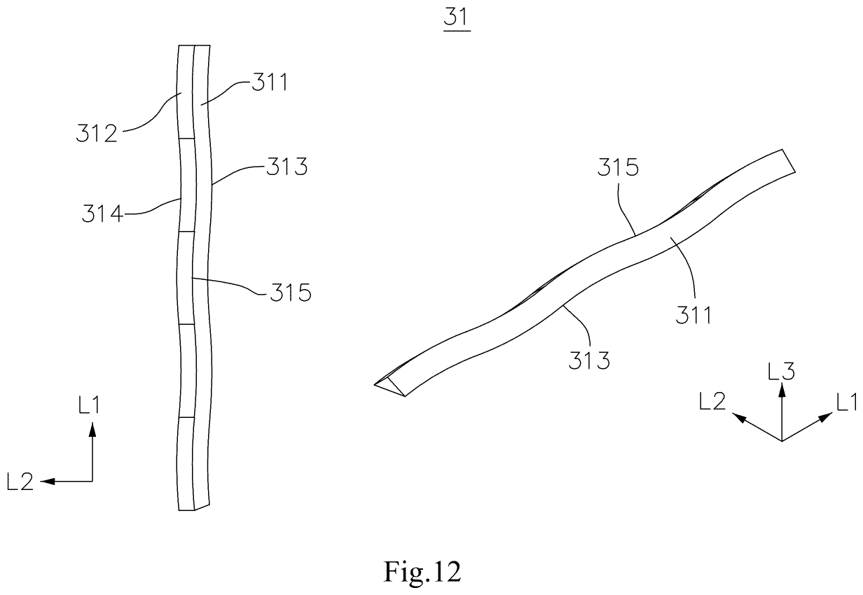

As shown in FIG. 12, the first boundary 313 is a line, the second boundary 314 is a line, and the ridge 315 is a third curve. The third curve is provided with a plurality of wave crests and a plurality of wave troughs alternately arranged. The plurality of wave crests and the plurality of wave troughs of the third curve are formed by variation of their amplitudes along a third direction L3. The third direction L3 is orthogonal to the first direction L1 and the second direction L2, i.e. the third direction L3 is perpendicular to the mounting surface 21. Therefore, the ridge 315 has varied heights with respect to the mounting surface 21 due to the alternately arranged wave crests and wave troughs. In other embodiments, the first boundary 313 and the second boundary 314 can be lines.

Therefore, the micro-structural bodies 31 extending along the first direction L1 are formed by any combination of arrangement or number of the micro-structural bodies 31 shown in FIGS. 9, 10, 11 and 12. Similarly, the micro-structural bodies 32 extending along the second direction L2 are formed by any combination of arrangement or number of different kinds of the micro-structural bodies 32 as the micro-structural bodies 31 shown in FIGS. 9, 10, 11 and 12. The union of the micro-structural bodies 31 and the micro-structural bodies 32 constitutes the light diffusion structure 30. The micro-structural bodies 31 and the micro-structural bodies 32 of various structures and shapes are combined according to different requirements to form various light diffusion structure 30 providing different light diffusion effects. For example, the ridges 315 of two adjacent micro-structural bodies 31 can be varied from 20 μm to 80 μm, and the height of the ridge 315 to the mounting surface 21 can be varied from 10 μm to 40 μm.

The light diffusion structure of the optical film for light diffusion is formed by a union of a plurality of micro-structural bodies extending along the first direction and the second direction. The first boundary, the second boundary and the ridge of each micro-structural body are formed by a line or a curve, and the curve is periodical or non-periodical. When multiple micro-structural bodies of different shapes or arrangements are combined, a structure composed of ridges and depressed portions alternately arranged is formed. When illuminating light beams pass through the micro-structural bodies, the light beams are scattered by the micro-structural bodies to travel at substantially the same angle for a uniform light diffusion effect.

The optical film for light diffusion can be applied to a display device. The display device includes a backlight module, the aforementioned optical film and a liquid crystal display panel. The backlight module emits a non-polarized light beam. The non-polarized light beam passes through the core layer of the optical film to form a polarized light beam, and the light diffusion structure diffuse the polarized light beam to form a two-dimensional light beam. The two-dimensional light beam passes through the liquid crystal display panel to form an image light beam.

While the invention has been described by way of example and in terms of pre-ferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical film for light diffusion, comprising:
a first substrate;
a core layer formed on the first substrate and configured to optically affect a light beam incident into the optical film, wherein the core layer comprises a mounting surface adjacent to the first substrate, and a first direction and a second direction mutually intersecting are defined on the mounting surface; and
a light diffusion structure formed on the mounting surface and configured to diffuse the light beam;
wherein the light diffusion structure comprises a micro-structured layer being a union of a plurality micro-structural bodies extending along the first direction and the second direction, each of the micro-structural bodies comprises a first surface and a second surface opposite to the first surface, the first surface intersects the mounting surface at a first boundary, the second surface intersects the mounting surface at a second boundary, the first surface intersects the second surface at a connection, the first boundary is a line or a first curve, the second boundary is a line or a second curve, the connection is a ridge or a rounded surface, and the ridge is a line or a third curve.

2. The optical film as claimed in claim 1, wherein the first curve is a first wavy curve having a plurality of wave crests and a plurality of wave troughs alternately disposed along the first direction or the second direction.

3. The optical film as claimed in claim 2, wherein the second curve is a second wavy curve having a plurality of wave crests and a plurality of wave troughs alternately disposed along the first direction or the second direction.

4. The optical film as claimed in claim 3, wherein the third curve is a third wavy curve having a plurality of wave crests and a plurality of wave troughs alternately disposed along the first direction or the second direction.

5. The optical film as claimed in claim 4, wherein the first boundary is the first wavy curve, the second boundary is the second wavy curve, the wave crests of the first wavy curve correspond to the wave crests of the second wavy curve, and the wave troughs of the first wavy curve correspond to the wave troughs of the second wavy curve.

6. The optical film as claimed in claim 4, wherein the first boundary is the first wavy curve, the second boundary is the second wavy curve, the wave crests of the first wavy curve of one of the micro-structural bodies corresponds to the wave crests of the first wavy curve of adjacent another one of the micro-structural bodies, and the wave troughs of the first wavy curve of one of the micro-structural bodies corresponds to the wave troughs of the first wavy curve of adjacent another one of the micro-structural bodies.

7. The optical film as claimed in claim 4, wherein the first boundary is the first wavy curve, the second boundary is the second wavy curve, the wave crests of the first wavy curve of one of the micro-structural bodies corresponds to the wave troughs of the first wavy curve of adjacent another one of the micro-structural bodies, and the wave troughs of the first wavy curve of one of the micro-structural bodies corresponds to the wave crests of the first wavy curve of adjacent another one of the micro-structural bodies.

8. The optical film as claimed in claim 7, wherein the ridge is the third wavy curve, the wave crests of the third wavy curve correspond to the wave crests of the first wavy curve, and the wave troughs of the third wavy curve correspond to the wave troughs of the first wavy curve.

9. The optical film as claimed in claim 6, wherein the ridge is the third wavy curve, the wave crests of the third wavy curve correspond to the wave crests of the first wavy curve, and the wave troughs of the third wavy curve correspond to the wave troughs of the first wavy curve.

10. The optical film as claimed in claim 5, wherein the ridge is the third wavy curve, the wave crests of the third wavy curve correspond to the wave crests of the first wavy curve, and the wave troughs of the third wavy curve correspond to the wave troughs of the first wavy curve.

11. The optical film as claimed in claim 3, wherein the first boundary is the line, the second boundary is the line, the ridge is a third wavy curve having a plurality of wave crests and a plurality of wave troughs alternately disposed along a third direction perpendicular to the first direction and the second direction.

12. The optical film as claimed in claim 1, wherein the second curve is a second wavy curve having a plurality of wave crests and a plurality of wave troughs alternately disposed along the first direction and the second direction.

13. The optical film as claimed in claim 1, wherein the micro-structured layer comprises a plurality of first ridges extending along the first direction and a plurality of second ridges extending along the second direction, at least one of the first ridges is continuous, and at least one of the second ridges is non-continuous.

14. The optical film as claimed in claim 13, wherein the micro-structured layer comprises a plurality of depressed portions, each of the depressed portions is disposed between two adjacent first ridges and two adjacent second ridges.

15. The optical film as claimed in claim 14, wherein each of the depressed portions has a bottom shaped as at least one or any combination of a group of geometrical structure composed of a point, a line, a curve, a plane or a conical surface.

16. The optical film as claimed in claim 1, wherein the first direction and the second direction intersect at an angle ranging from 45° to 135°.

17. The optical film as claimed in claim 1, wherein the light diffusion structure further comprises a second substrate formed on the core layer, and the micro-structured layer is formed on the second substrate.

18. The optical film as claimed in claim 1, wherein the rounded surface has a radius of curvature ranging from 0.2 μm to 30 μm in the first direction or the second direction.

19. A display device, comprising,
a backlight module emitting a non-polarized light beam;
the optical film as claimed in claim 1, wherein the non-polarized light beam passes through the core layer of the optical film to form a polarized light beam, and the light diffusion structure diffuse the polarized light beam to form a two-dimensional light beam; and
a liquid crystal display panel, wherein the two-dimensional light beam passes through the liquid crystal display panel to form an image light beam.
